(19) United States
(12) Patent Application Publication
(10) Pub. No.: US 2021/0067083 A1
(43) Pub. Date: Mar. 4, 2021

(54) KIT OF CROSS-COMPATIBLE PARTS FOR MULTIPLE SOLAR INSTALLATION METHODS

(71) Applicant: PEGASUS SOLAR, INC., Richmond, CA (US)

(72) Inventors: Erich Kai Stephan, Richmond, CA (US); Glenn Harris, Sausalito, CA (US); Peter Wilke, Richmond, CA (US); Nicholas Wenzel, Richmond, CA (US)

(21) Appl. No.: 17/001,357

(22) Filed: Aug. 24, 2020

Related U.S. Application Data
(60) Provisional application No. 62/891,831, filed on Aug. 26, 2019.

(51) Int. Cl. H02S 20/23; F24S 25/634; F24S 25/632

(52) U.S. Cl. CPC H02S 20/23; F24S 25/632; F24S 25/634

(57) ABSTRACT

Combinations of various solar module mounting components are tested and certified for use in mounting solar modules. The components are tested and certified for use in different configurations, allowing them to be cross-compatible. The different configurations include dual-rail systems, shared-rail systems, and rail-free systems.

### CROSS-REFERENCE TO RELATED APPLICATION

This application claims the benefit of U.S. Provisional Application No. 62/891,831 entitled KIT OF CROSS-COMPATIBLE PARTS FOR MULTIPLE SOLAR INSTALLATION METHODS, filed on Aug. 26, 2019, the full disclosure of which is incorporated herein in its entirety.

### BACKGROUND

Currently there are several types of systems to mount solar modules on a sloped roof, many which require a different installation method and sets of components. The most common types of solar mounting systems can be grouped into three main categories: dual-rail, shared-rail, and rail-free. These three main mounting system types require different sets of components that are predominantly not cross-compatible. Each system type has its advantages based on geography, structural requirements, user preference, and other factors. For some users, it may be advantageous to use all three types of systems on a regular basis, selecting a method and system based on the parameters of any given solar installation.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be limiting of its scope, the principles herein are described and explained with additional specificity and detail through the use of the accompanying drawings in which:

FIG. 1 illustrates a kit of common components that are cross-compatible to install in the method of a dual-rail, shared rail, or rail-free method;

FIG. 2 depicts a first step of arranging the flashings for a dual-rail installation method;

FIG. 3A depicts a second step wherein the L-feet attachments are installed on the flashings;

FIG. 3B depicts a third step where a first pair of rails are installed to the L-feet;

FIG. 3C depicts a fourth step where a second pair of rails are installed to the next two rows of L-feet;

FIG. 3D depicts a fifth step where a first solar modules is placed on the first pair of rails;

FIG. 3E depicts a sixth step where additional solar modules are arranged on a first row of rails;

FIG. 3F depicts a seventh step where a second row of solar modules are installed on a second pair of rails;

FIG. 4A depicts an alternative step after FIG. 3B or 3C where one or more skirts are installed to a rail;

FIG. 4B depicts a final installation of a dual-rail installation method;

FIG. 5A depicts a first step in the skip-rail installation method wherein multiple flashings and L-feet are arranged on a rooftop surface;

FIG. 5B depicts a second step where a first pair of rails are installed to the L-feet;

FIG. 5C depicts a third step where a solar module is placed on the first pair of rails;

FIG. 5D depicts a fourth step where module splices are attached on the top side of solar modules;

FIG. 5E depicts a fifth step where a second row of solar modules are installed on the third rail and secured to the module splices;

FIG. 5F depicts a possible step where one or more skirts are installed to a solar module;

FIG. 5G depicts a close-up view of FIG. 5E where the first row of solar modules are joined with the second row of solar modules with module splices;

FIG. 5H depicts a different perspective view of FIG. 5G;

FIG. 6A depicts a first step in the rail-free installation method wherein multiple flashings are arranged on a rooftop surface;

FIG. 6B depicts a second step wherein multiple flex mounts are installed of the flashings;

FIG. 6C depicts a third step wherein one or more skirts are installed to one or more flex mounts;

FIG. 6D depicts a fourth step wherein one or more module splices may be attached to the skirt;

FIG. 6E depicts a fifth step wherein a first row of solar modules is installed;

FIG. 6F depicts a sixth step where a second row of solar modules are installed using the second and third row of flex mounts;

FIG. 7A depicts a close-up view of the bottom edge of solar modules after installation;

FIG. 8A depicts a close-up view of the top edge of the first row of solar modules;

FIG. 8B depicts a side view of FIG. 8A;

FIG. 9A is a side view of the bottom edge of the first row of solar modules;

FIG. 10A depicts a close-up view of the top edge of the second row of solar modules;

FIG. 11A depicts a possible iteration of an end-clamp; and

FIG. 12 illustrates steps in an example method according to the disclosed features.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Solar modules generate electricity, which can be used in an off-grid location, or the system can be connected to a power grid and excess energy may be pushed to the power grid. Regardless of whether the solar modules are used off-grid or on-grid, they are generally capable of generating energy at levels that can be very dangerous or fatal if not properly configured and installed. To help ensure that solar systems are safe, the installation is typically inspected and approved by a local electrical authority, such as through a permitting process. The local authority operates according to codes that apply within the jurisdiction. In the United States, the National Electrical Code (NEC) is such a code and it has been adopted in all 50 states. Most or all of these codes require that any solar system has been tested and complies with a recognized testing standard. In the United States, the UL, CSA Group and ETL are examples of a recognized testing standard or organization. In the European Union and Australia, CE and EESS are respective examples of such a recognized testing standard.

In order to pass an inspection and sign-off on a permit, an inspector will determine whether the combination of components are listed according to one of the recognized standards, and whether those components have been installed according to the appropriate building code. Unless all of these requirements are satisfied, the solar installation is unpermitted.

The process for testing components so the combination of components can be listed according to one of the recognized standards, typically involves submitting samples to a testing lab, where the samples are subjected to various conditions. As an example, testing of components to mount solar modules so they can be UL listed, might include evaluation, testing and certification to UL 2703.

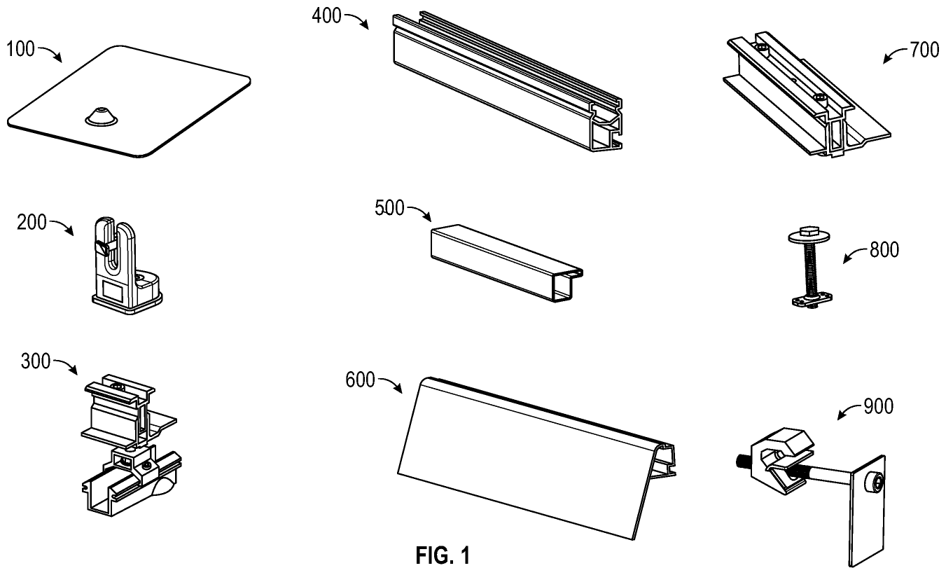

FIG. 1 illustrates a kit of common components that can be used to install a rooftop solar system using all three dual-rail, shared-rail, or rail-free installation methodologies. The kit of components could be delivered as a set, and at the time of installation, the user may pre-select which installation method would be best given a roof's characteristics prior to arrival at the installation site. In the kit there may be the following components: the flashing 100, the L-foot 200, the flex-mount 300, the rail 400, the rail-splice 500, the skirt 600, the module splice 700, the mid-clamp 800, and the end-clamp 900. The kit may contain none of each component, or multiple of each component. The kit may contain a different quantity of each component.

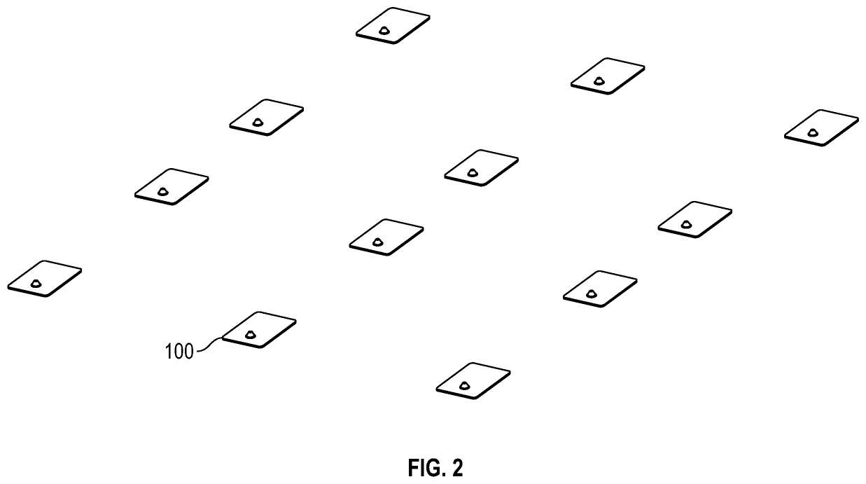

FIG. 2 depicts a first step in the dual-rail installation method wherein multiple flashings 100 are arranged on a rooftop surface. The flashings 100 are arranged in a manner such that in later steps, the rails 400 are spaced to properly support solar modules as is customary in the art. Often, such spacing will be pre-determined based on structural and loading requirements (e.g. snow loading) of a given installation location.

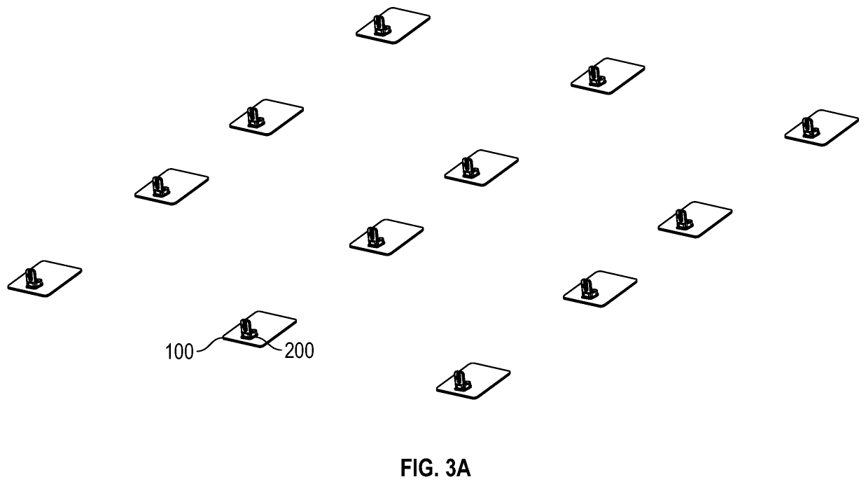

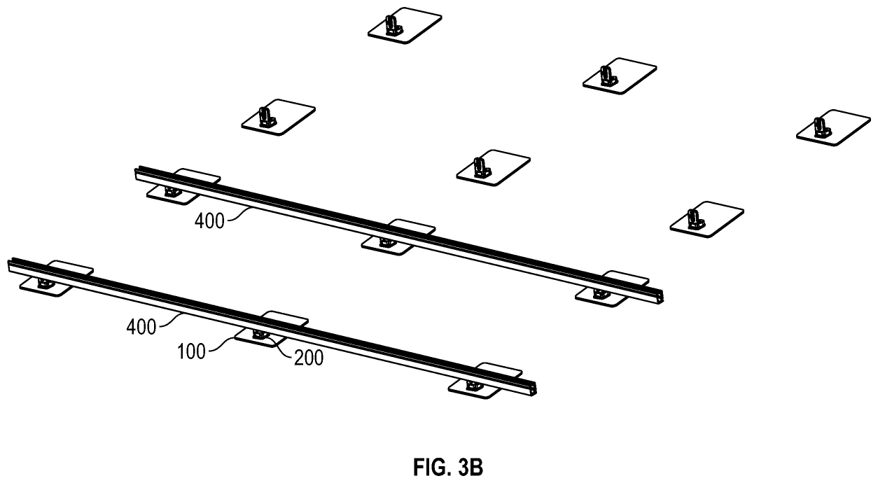

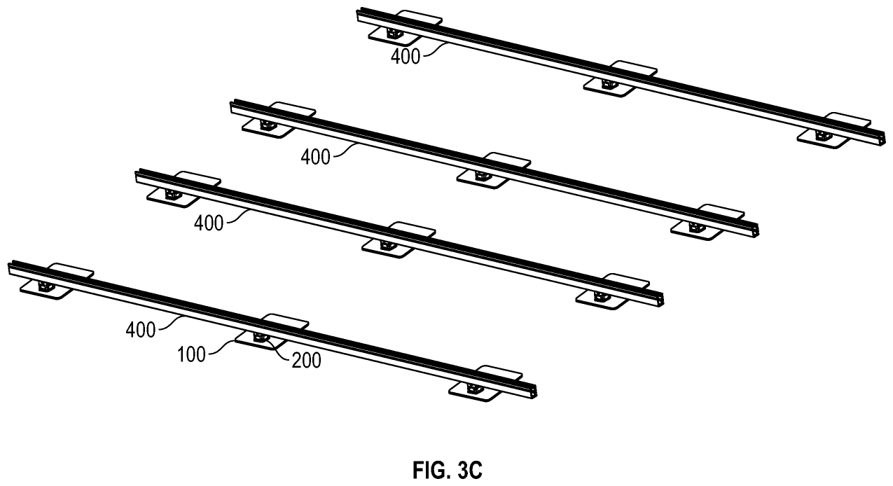

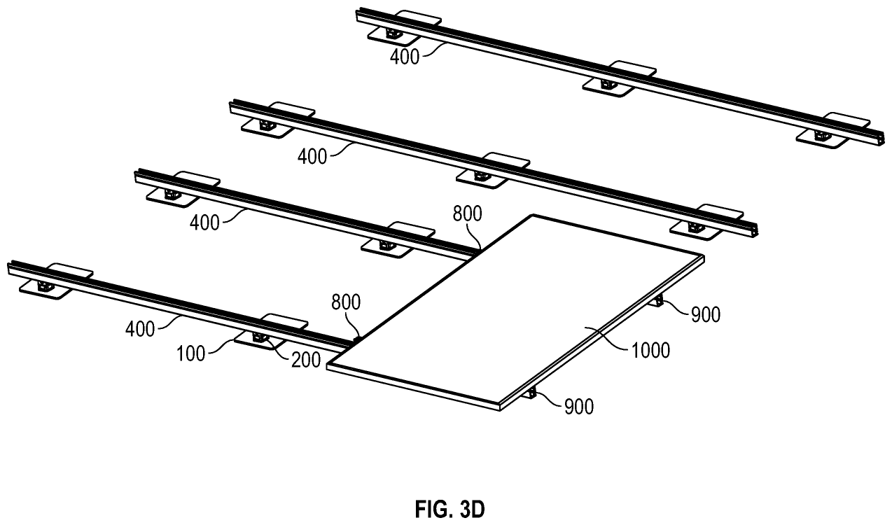

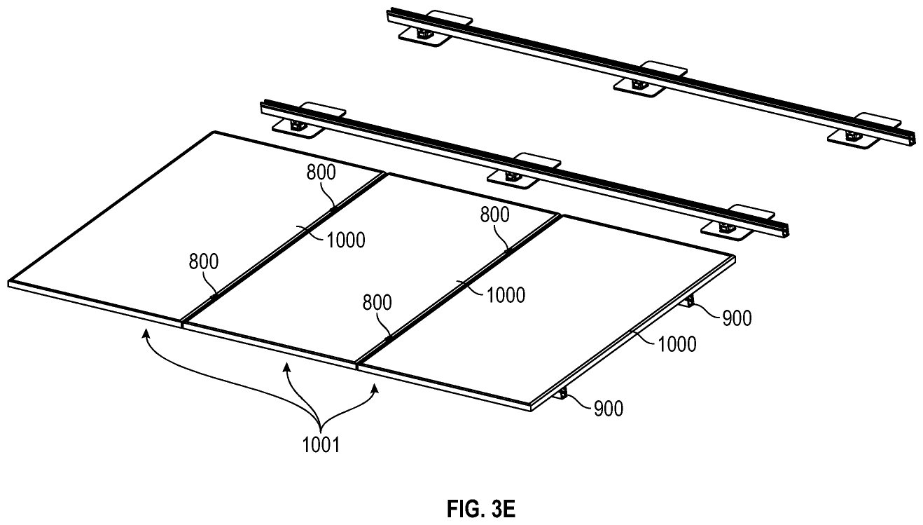

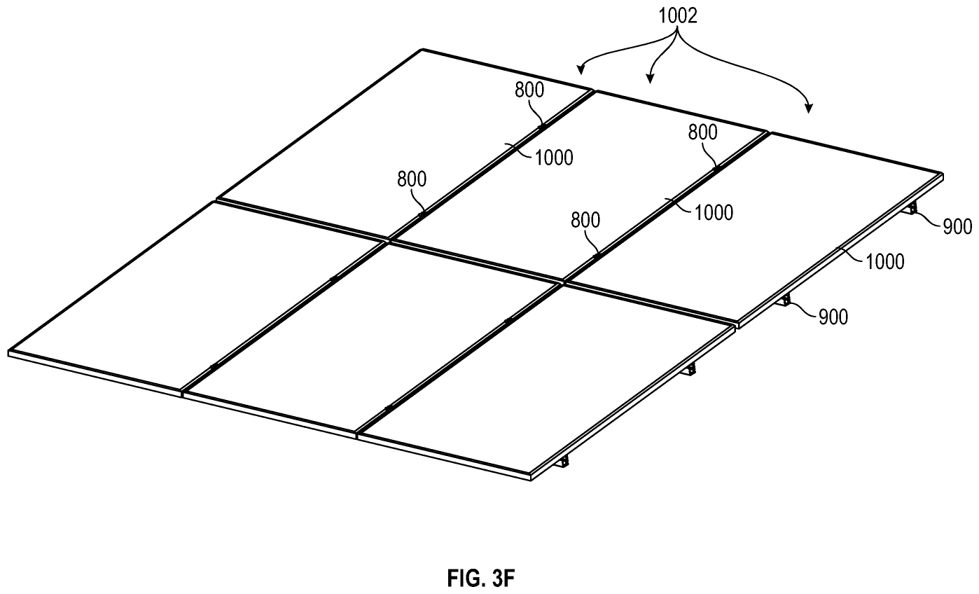

FIG. 3A depicts a second step after FIG. 2 wherein multiple L-feet 200 are installed over the flashings 100 using a fastener (not shown). The fastener secures the L-feet 200 and the flashings 100 to the rooftop surface.

FIG. 3B depicts a third step of the dual-rail installation method where a first pair of rails 400 are installed to the L-feet 200. The two sets of rails 400 may be arranged such that a series of solar modules may fit evenly over the two rails. In other embodiments not shown, should a row of solar modules exceed the length of a rail 400, a second set of rails may be installed and coupled to the first set using rail-splices 500. A rail-splice 500 may slide inside a rail 400 or outside like a sleeve of rail 400. The rail-splice 500 may secure to a rail 400 using a metal snap, clip self-tapping fastener, or bolt and nut type fastener.

FIG. 3C depicts a fourth step of the dual-rail installation method where a second pair of rails 400 are installed to the next two rows of L-feet 200. Based on the spacing of the flashings 100, this second set of rails 400 may be spaced apart from one another substantially similar to the first row of rails 400. Further, based on the spacing of the flashings 100, the first pair of rails 400 may be spaced away from the second pair of rails 400 some distance such that at a later step, the solar modules would be properly supported and nearly coincident, as later shown in FIG. 3E.

FIG. 3D depicts a fifth step of the dual-rail installation method where a first solar module 1000 is placed on the first pair of rails 400. The first solar module 1000 may be installed on the left end of the pair of rails, on the right end, or somewhere in-between the ends of the rails 400. Once this first solar module 1000 is aligned to the desired location, one or more end clamps 900 may be installed to the end of one or more rails 400 and tightened to secure the first solar module 1000 into place. One or more mid-clamps 800 may be installed to one or more rails 400 and loosely tightened to the first solar module 1000. In other embodiments of the present invention, the mid-clamps may be installed to the rail before the end-clamps, or the mid-clamps 800 and end-clamps 900 may be installed at the same time. The mid-clamps and end-clamps may also be installed to the rail 400 before the first solar module 1000 is placed on the first pair of rails 400.

FIG. 3E depicts a sixth step of the dual-rail installation method where additional solar modules 1000 are arranged on a first row of rails 400. The additional solar modules 1000 may be arranged such that the bottom edge 1001 of each solar module 1000 is substantially coincident with one another. A mid-clamp 800 may be installed to each rail 400 between each solar module 1000. An end-clamp 900 may be installed to the end of the of each rail 400 to secure a solar module 1000 a rail 400.

FIG. 3F depicts a seventh step of the dual-rail installation method where a second row of solar modules 1002 are installed on a second pair of rails 400. The second row of solar modules 1002 may be in contact with the first row of solar modules 1000, or the two rows may have a gap. The top surfaces of the solar modules 1000 and 1002 may be substantially in plane with one another. Similar to the process in steps five and six described in FIGS. 3D and 3E, mid-clamps 800 and end-clamps 900 may be installed to the rails 400 to secure the solar modules 1000 and 1002 onto the rails 400.

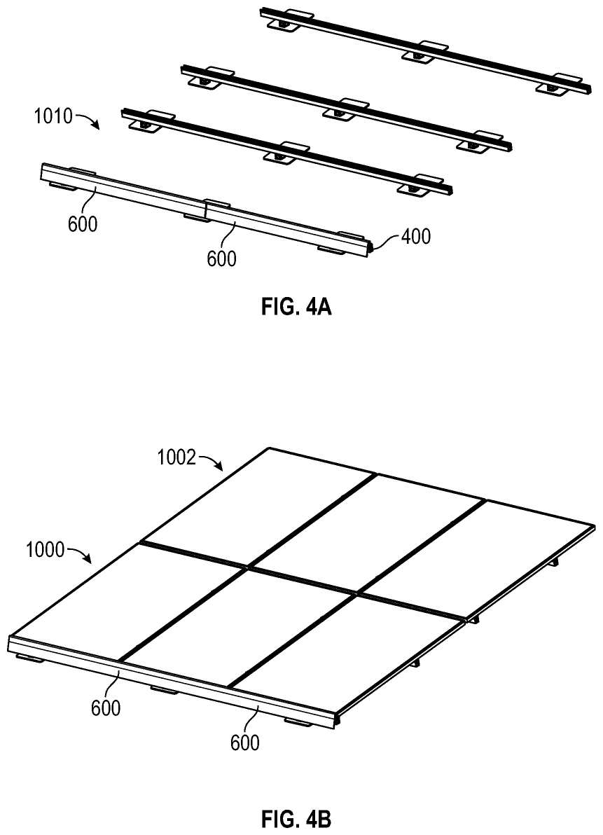

FIG. 4A depicts an alternative step after FIG. 3B or 3C where one or more skirts 600 are installed to a rail 400 in a first position 1010. The one or more skirts 600 may be installed to a rail 400 using a fastener, spring, clip, snap, or other suitable mechanical device. If multiple skirts 600 are used, a rail splice 500 may be used to adjoin the skirts 600 to one another.

FIG. 4B depicts the final installation from FIG. 4A after one or more solar modules 1000 have been installed and one or more mid-clamps 800 and one or more end-clamps 900 have been installed. In this example of the present invention, the first row of solar modules 1000 are positioned so the down-roof edge of the solar modules 1000 is near the up-roof edge of a skirt 600. In this example embodiment, the solar modules 1000 may be coincident with the skirt 600 or they may be spaced away from a skirt 600 some distance. In this example, the positioning of the first row of solar modules 1000 relative the first pair of rails 400 affects the positioning of the second row of solar modules 1002 relative to the second pair of rails 400. In this example and in the examples shown in FIG. 3F, the spacing between the first row of solar modules 1000 and second row of solar modules 1002 are substantially similar.

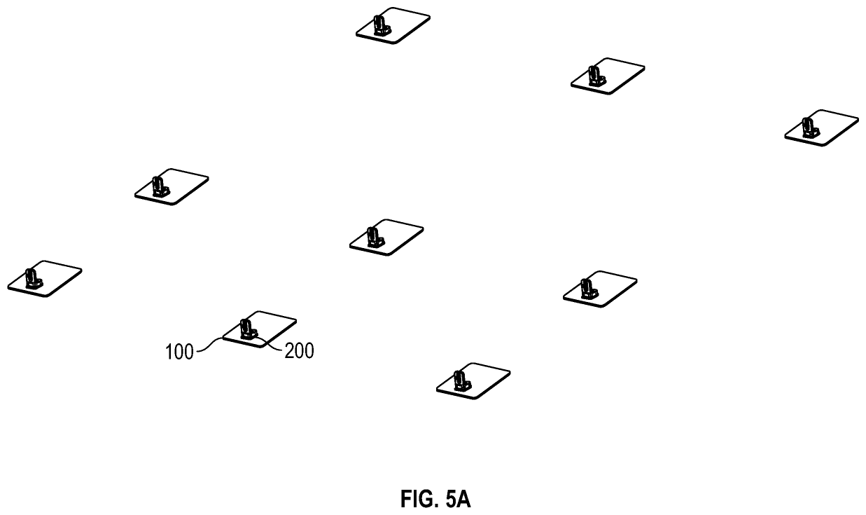

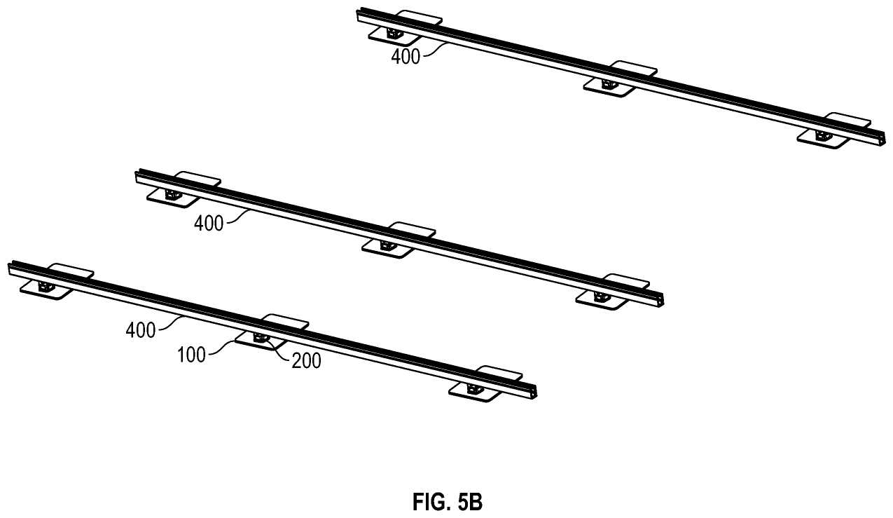

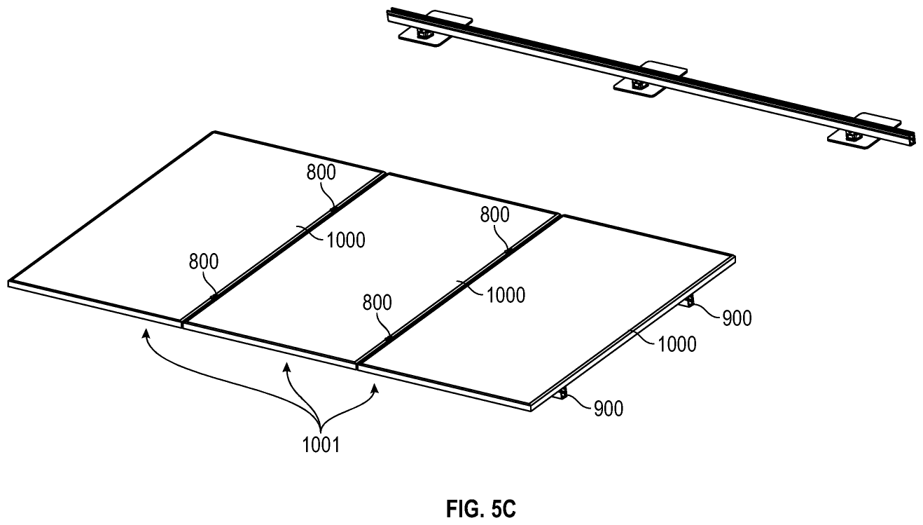

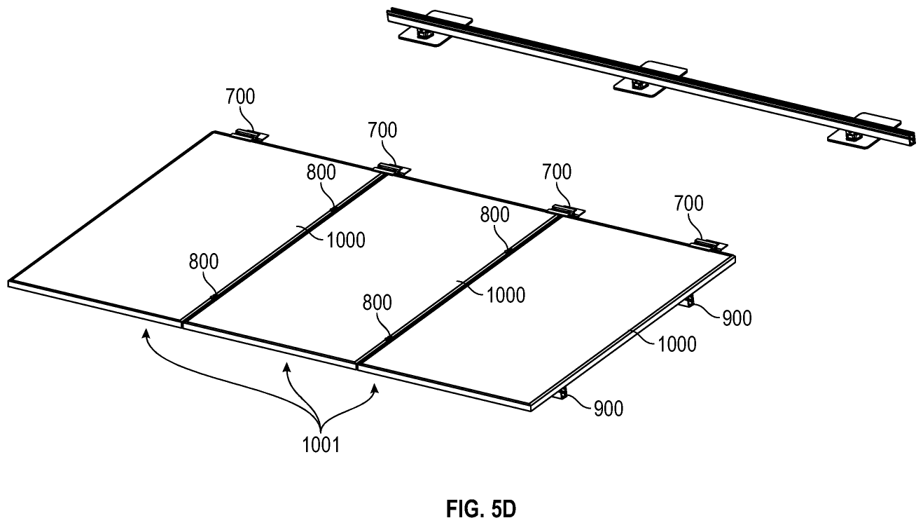

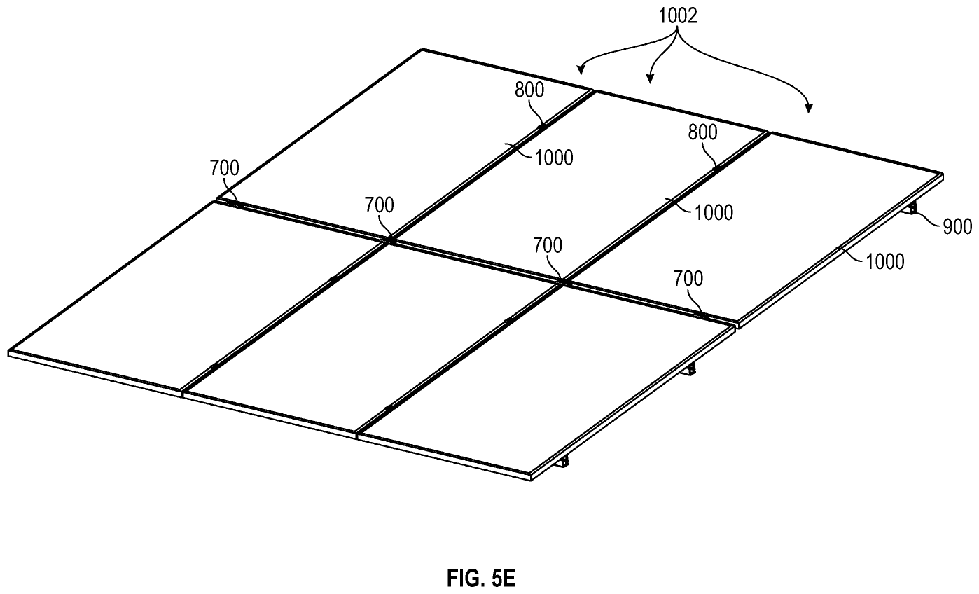

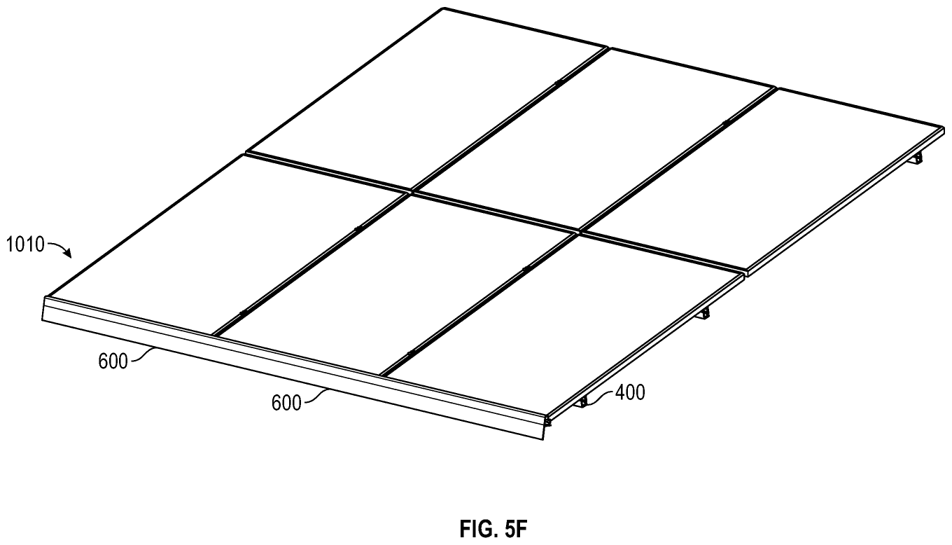

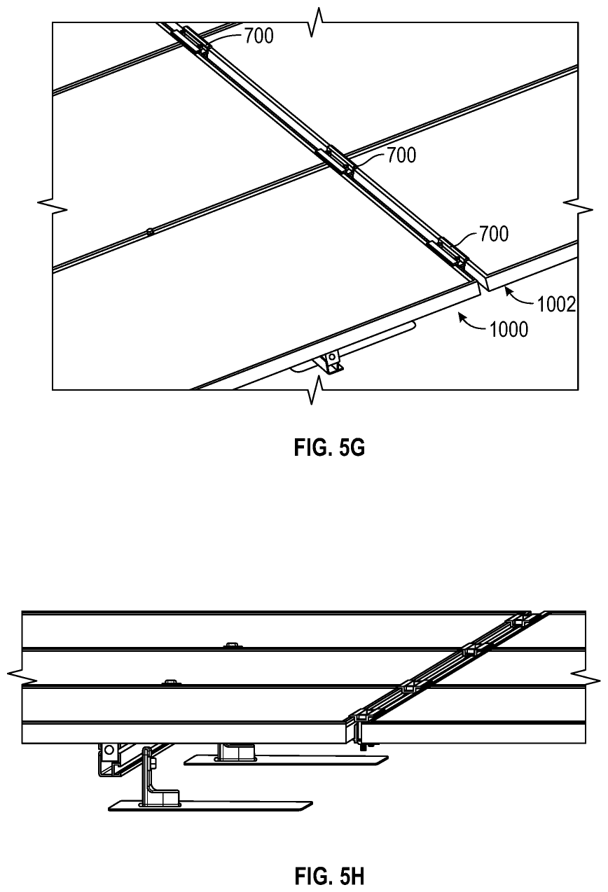

FIG. 5A depicts a first step in the skip-rail installation method wherein multiple flashings 100 and L-feet 200 are arranged on a rooftop surface. The L-feet 200 are secured to the flashing 100 and the rooftop surface with a fastener (not shown). The flashings 100 and L-feet 200 are arranged similar to the description in FIG. 2, however the third row of flashings is not installed. Fewer parts are needed for the skip-rail installation as only three rows, instead of four rows of flashings 100 and L-feet 200 are needed for the same installation as the dual-rail installation depicted in FIGS. 2 and 3A.

FIG. 5B depicts a second step in the skip-rail installation method where a first pair of rails 400 are installed to the L-feet 200. The pair of rails 400 may be arranged such that a series of solar modules will fit evenly over the two rails in later steps of the installation process. A third rail 400 is installed to the L-feet above the first pair of L-feet 200. In this skip-rail installation, only three rails 400 are required, instead of the four rails 400 required for a dual-rail installation described in FIGS. 3A-3E. In other embodiments not shown, should a row of solar modules exceed the length of a rail 400, a second set of rails may be installed and coupled to the first set using rail-splices 500. A rail-splice 500 may slide inside a rail 400 or outside like a sleeve of rail 400. The rail-splice 500 may secure using a metal snap, clip self-tapping fastener, or bolt and nut type fastener.

FIG. 5C depicts a third step of the skip-rail installation method, which is similar to the fifth step of a dual-rail installation method, where a first solar module 1000 is placed on the first pair of rails 400. The first solar module 1000 may be installed on the left end of the pair of rails, on the right end, or somewhere in-between the ends of the rails 400. Once this first solar module 1000 is aligned to the desired location, one or more end-clamps 900 may be installed to the end of one or more rails 400 and tightened to secure the first solar module 1000 into place. One or more mid-clamps 800 may be installed to one or more rails 400 and loosely tightened to the first solar module 1000. In other embodiments of the present invention, the mid-clamps may be installed to the rail before the end-clamps, or the mid-clamps and end-clamps may be installed at the same time. The mid-clamps and end-clamps may also be installed to the rail 400 before the first solar module 1000 is placed on the first pair of rails 400.

FIG. 5D depicts a fourth step of a skip-rail installation method where module splices 700 are attached on the top side of the first row of solar modules 1000. Module splices 700 may be placed at each intersection between solar modules 1000 within the same row. One module splice 700 may also be installed on the furthest left and another module splice 700 may be installed on the furthest right edge of a row of solar modules. Thus, in this example embodiment, a total of four module splices 700 are used for three solar modules 1000. Thus, for n number of solar modules 1000, n+1 number of module splices 700 may be installed between each row of solar modules 1000. A similar quantity or formula for number of module splices 700 may be used in subsequent rows of solar modules 1000, e.g. a third or forth row of solar modules 1000.

FIG. 5E depicts a fifth step of a skip-rail installation method where a second row of solar modules 1002 are installed on the third rail 400 and secured to the module splices 700. The module splices 700 support the bottom edge of the second row of solar modules 1002. The third rail 400 supports the upper portion of the second row of solar modules 1002 such that the top surfaces of solar modules 1000 and 1002 may be substantially in plane with one another. Similar to the process in step three described in FIG. 5C, mid-clamps 800 and end-clamps 900 may be installed to the rails 400 to secure the solar modules 1000 and 1002 onto the rails 400.

FIG. 5F depicts a possible step after FIG. 5E where one or more skirts 600 are installed to a solar module 1000 in a first position 1010. The one of more skirts 600 may be installed to a solar module 1000 using a fastener, spring, clip, snap, or other suitable mechanical device. If multiple skirts 600 are used, a rail splice 500 may be used to adjoin the skirts 600 to one another.

FIG. 5G depicts a close-up view of FIG. 5E where the first row of solar modules 1000 are joined with the second row of solar modules 1002 with module splices 700. The first row of solar modules 1000 is supported by the first pair of rails 400. The next row of solar modules 1002 is supported by the third rail 400 and the module splices 700. In this way, two rows of solar modules 1000 can be installed with only three rows of flashings 100, L-feet 200, and rails 400.

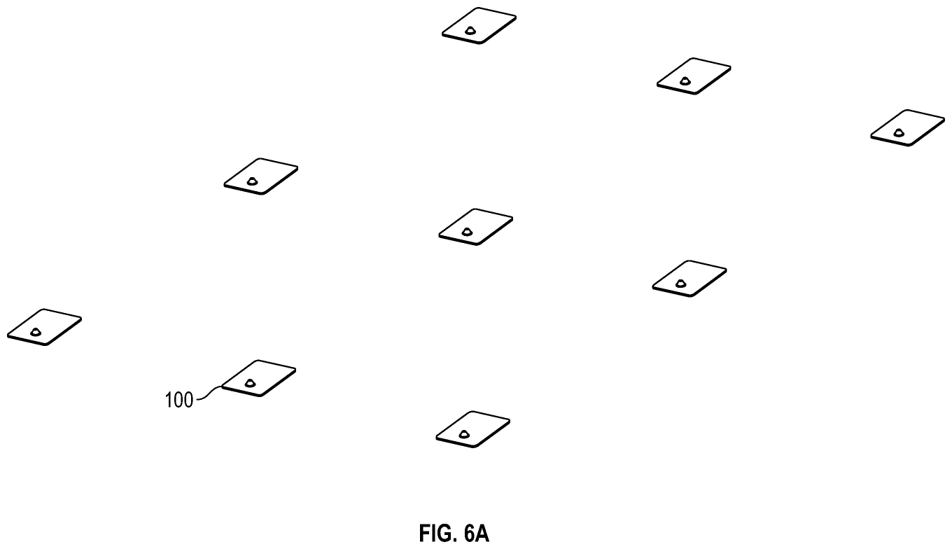

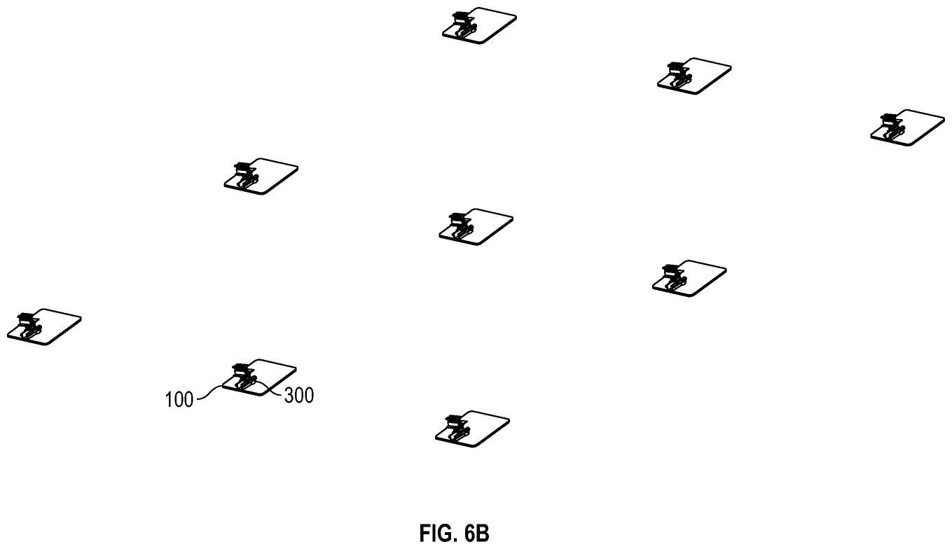

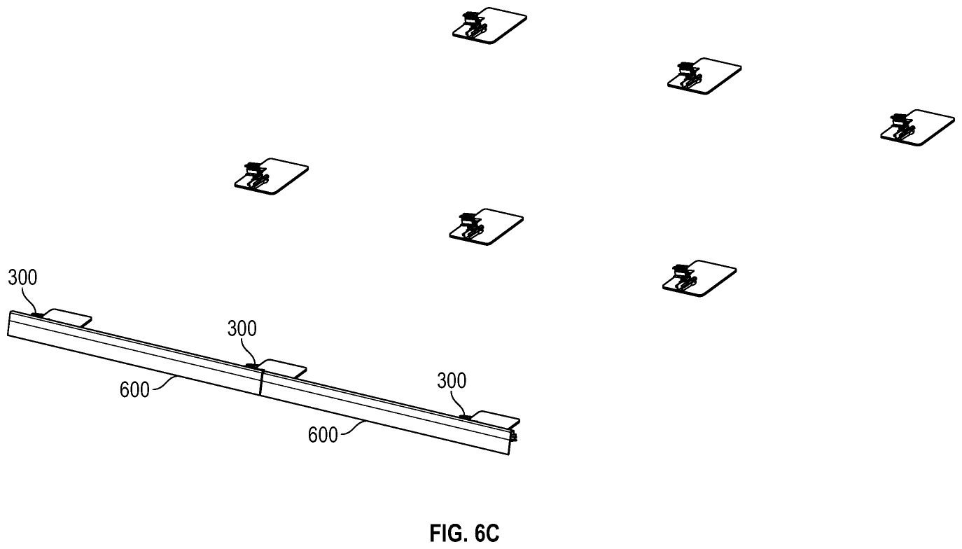

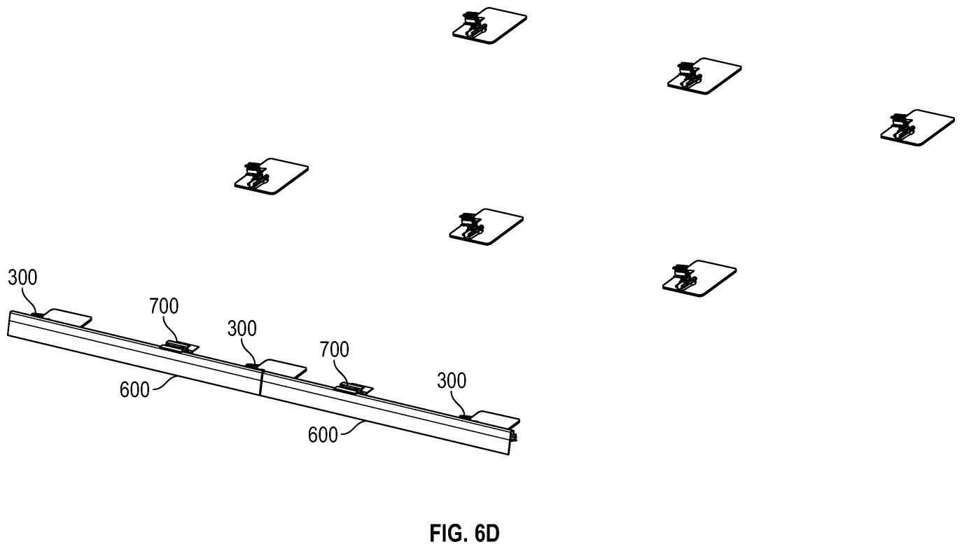

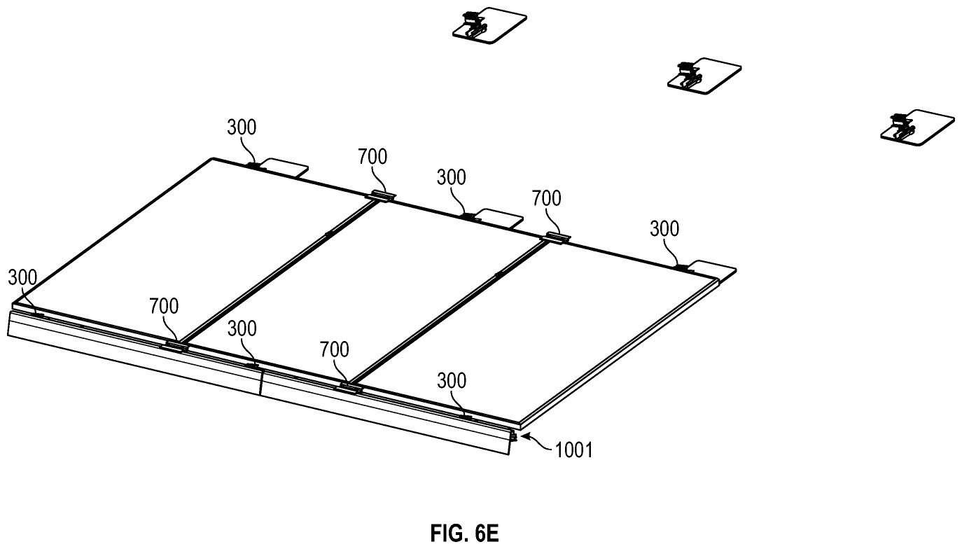

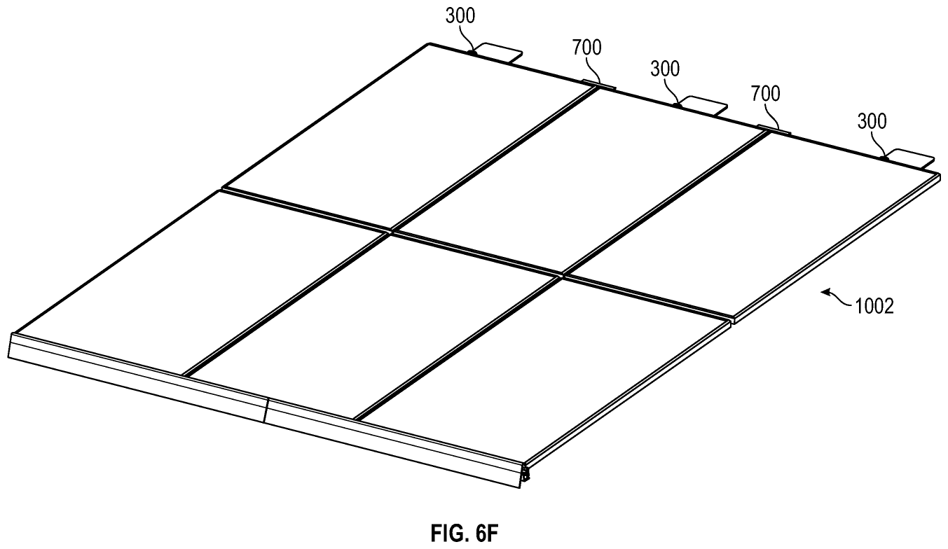

FIG. 6A depicts a first step in the rail-free installation method wherein multiple flashings 100 are arranged on a rooftop surface. The flashings 100 are arranged in a manner such that in later steps, the flex-mounts 300 are spaced to properly support solar modules 1000 along the short or long edges of the solar modules 1000. Often, such spacing will be pre-determined based on structural and loading requirements (e.g. snow loading) of a given installation location.

FIG. 6B depicts a second step after FIG. 6A wherein multiple flex mounts 300 are installed over the flashings 100 using a fastener (not shown). The fastener secures the flex mount 300 and the flashings 100 to the rooftop surface.

FIG. 6C depicts a third step after FIG. 6B wherein one or more skirts 600 are installed to one or more flex mounts 300. The one or more skirts 600 may be installed to a flex mount 300 using a fastener, spring, clip, snap, clamp, or other suitable mechanical device. If multiple skirts 600 are used, a rail splice 500 may be used to adjoin the skirts 600 to one another.

FIG. 6D depicts a fourth step after FIG. 6C wherein one or more module splices 700 may be attached to the skirt 600. The module splices 700 may be clamped to the skirt 600 with a fastener (not shown). In some embodiments, the module splices 700 may secure two skirts 600 together, and two solar modules 1000 together.

FIG. 6E depicts a fifth step after FIG. 6D wherein a first row of solar modules 1000 is installed. The bottom edge 1001 of the solar modules 1000 are clamped in the flex mount 300 and the module splices 700. The module splices 700 on the bottom edge 1001 join the solar modules 1000 together. Thus, for two solar modules 1000, two module splices 700 are required. Thus, if the number of solar modules 1000 is n, then the number of required module splices 700 along one edge of solar modules 1000 is n−1. The top edge of the first row of solar modules 1000 is clamped by the second row of flex mounts 300. Much like the bottom edge 1001, module splices 700 are similarly attached at joints of two solar modules 1000.

FIG. 6F depicts a sixth step after FIG. 6D wherein a second row of solar modules 1002 are installed using the second and third row of flex mounts 300. The installation of this second row of solar modules 1002 follows the same process as described in FIG. 6E and is the same for any number of rows of solar module 1000. In other embodiments not shown, the rows of solar modules 1000 may not be aligned at the edges of subsequent rows, or the rows may have different quantities of solar modules 1000. As such, a module splice 700 may connect two modules in one row, but only clamp to one solar module in an adjacent row.

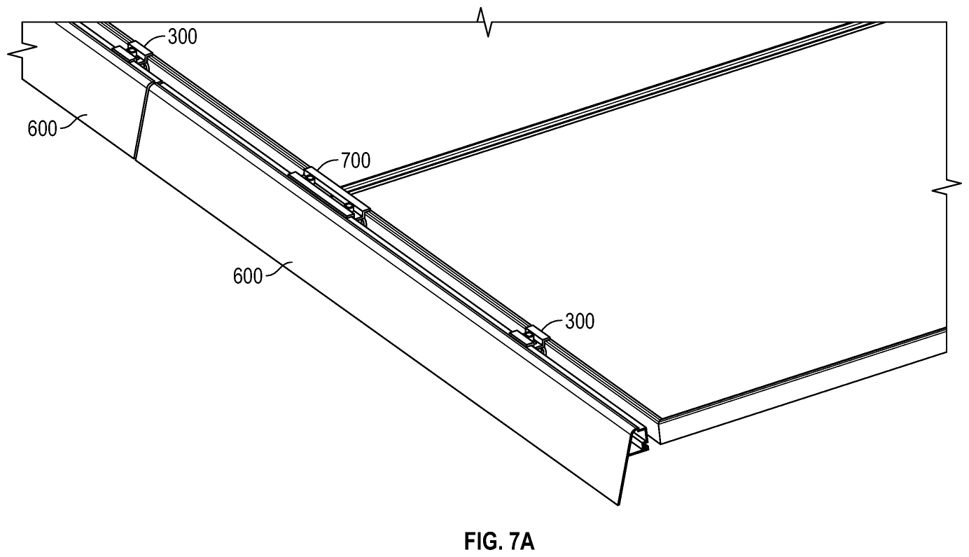

FIG. 7A depicts a close-up view of the bottom edge 1001 of solar modules 1000 after installation. In this example embodiment, the solar modules 1000 are clamped by both the flex mount 300 and the module splice 700. The flex mount 300 secures the solar modules 1000 to the rooftop surface, and the module splice 700 secures adjacent solar modules 1000. In this example rail-free installation method, the skirt 600 does not attach directly to the solar modules 1000, but rather the skirt 600 may be secured to one or both the flex mount 300 and module splice 700.

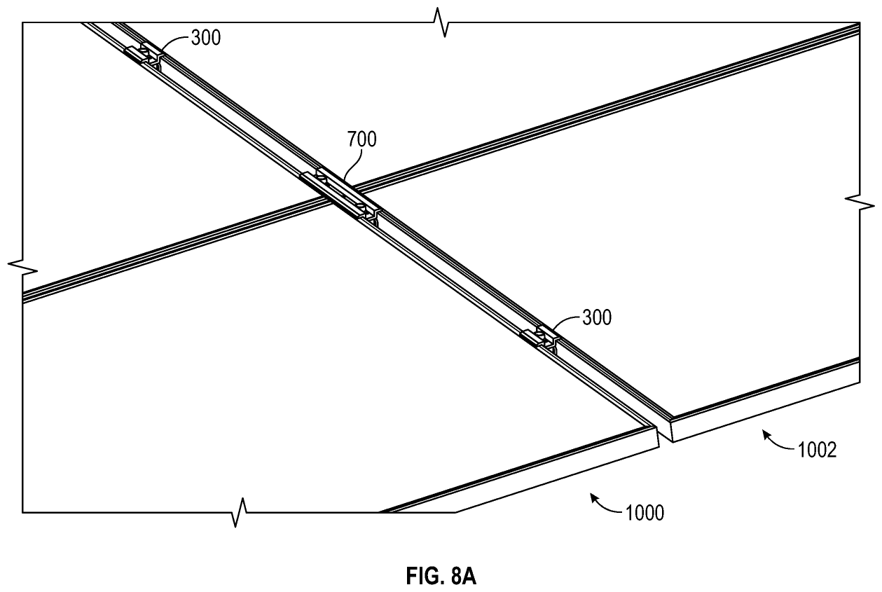

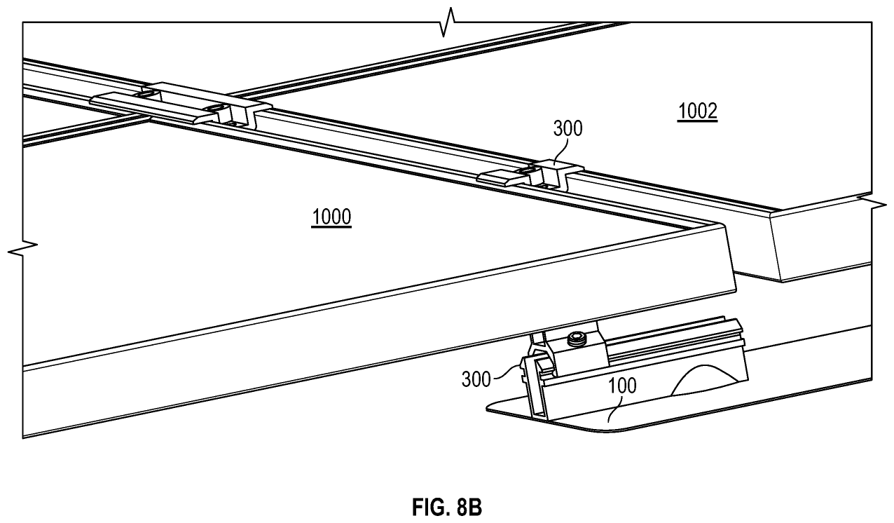

FIG. 8A depicts a close-up view of the top edge of the first row of solar modules 1000 after installation using the rail-free method. The solar modules 1000 are clamped by both the flex mount 300 and the module splice 700. In this example, the flex mount 300 and the module splice 700 secure the first row of solar modules 1000 to the second row of solar modules 1002.

FIG. 8B depicts a side view of FIG. 8A, illustrating how the flex mount 300 is attached to the rooftop surface under the solar modules 1000. The flex mount 300 may have an adjustable slide, slot or other adjustable mechanism such that the clamp may be moved to the edge of a solar module 1000 after the base portion of the flex mount 300 is secured to the rooftop surface. The flex mount 300 may have a set screw or similar fastener that can be threadably engaged to fix the clamp assembly on the flex mount 300 into a desired location.

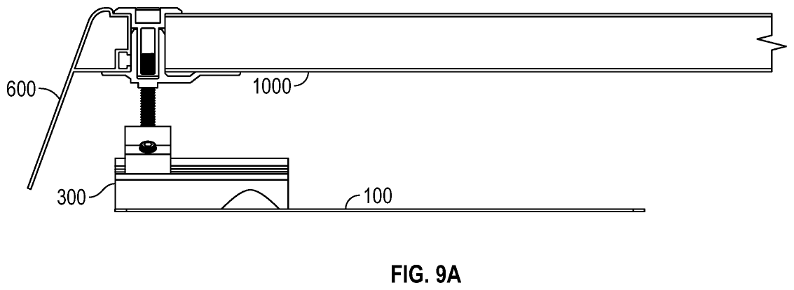

FIG. 9A is a side view of the bottom edge 1001 of the first row of solar modules 1000. The flex mount 300 may have all the same features as described in FIG. 8B such that the mount may be adjusted along the length of the slider/channel. The flex mount 300 may clamp the skirt 600 such that a secondary fastener, clip, or other mechanical device is not required.

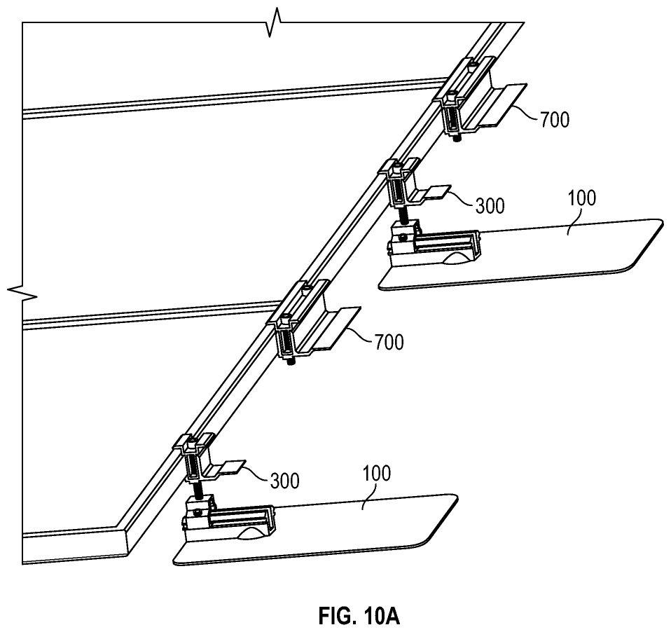

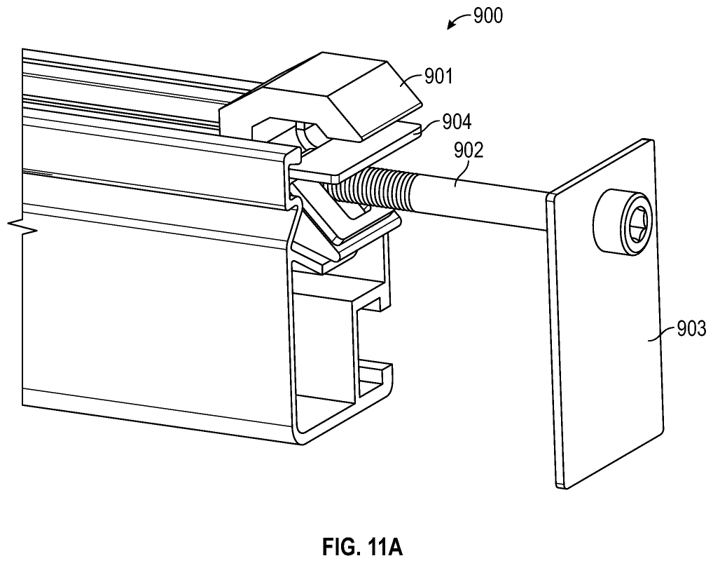

FIG. 10A depicts a close-up view of the top edge of the second row of solar modules 1002. As similarly described in FIGS. 6E and 7A, the flex mount 300 secures the solar modules 1002 to the rooftop surface and the module splices 700 secure two or more solar modules 1000 together.

FIG. 11A depicts a possible iteration of an end-clamp 900. End-clamp 900 may have a clamp piece 901 that fits within the channel of rail 400. A fastener 902 may threadably engage into the clamp piece 901. A flush plate 903 may mate with the fastener 902 such that the flush plate 903 contacts the end of the rail 400. Once the flush plate 903 contacts the end of the rail 400 and the fastener 902 is threadably engaged, the clamp piece 901 will move along the channel toward the flush plate 903. When a solar module 1000 is installed, this clamp piece contacts the flange of the solar module 1000 which inhibits its motion toward the flush plate 903. At this point, continuing to threadably engage the fastener 902 will force the flanged section 904 of the clamp piece 901 to compress the flange of solar module 1000 onto the rail 400, thus securing the solar module 1000 to the rail 400.

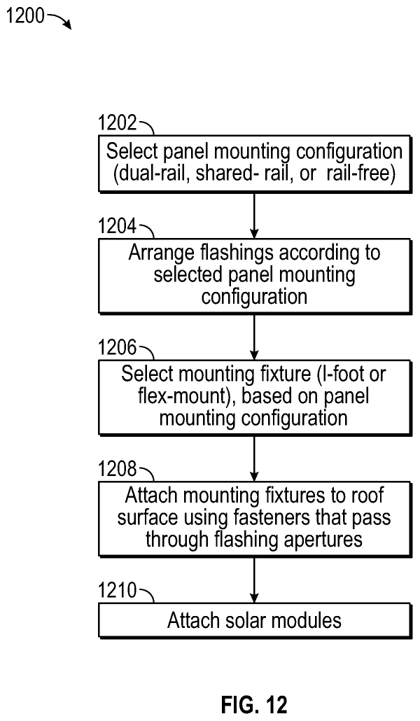

FIG. 12 illustrates steps in a method 1200, where a panel mounting configuration is selected at step 1202. That configuration might be a dual-rail system, such as illustrated in FIGS. 3 and 4. Alternatively, that configuration might be a shared-rail system, such as illustrated in FIG. 5. Finally, that configuration might be a rail-free system, such as illustrated in FIG. 6.

Once the panel mounting configuration is selected, then at step 1204, flashings 100 are arranged on the roof surface according to the panel mounting configuration. Here, as illustrated in FIG. 2, the flashings 100 are arranged according to a dual-rail configuration. FIG. 5 illustrates the flashings 100 arranged according to a shared-rail configuration. Finally FIG. 6 illustrates the flashings 100 arranged according to the rail-free configuration.

There are at least two mounting fixtures, the L-foot illustrated as 200 in FIG. 1, and the flex-mount illustrated as 100 in FIG. 1. The L-foot 200 is generally used with either the dual-rail or shared-rail system, while the flex-mount 300 is used with the rail-free system. At step 1206, the respective mounting fixture is selected based on the panel mounting configuration.

At step 1208, the mounting fixtures are attached to the roof, by a fastener that passes through the mounting fixture and the aperture in the flashing 100.

Then at step 1210 the solar modules are attached. If a dual-rail configuration or a shared-rail configuration is selected, then rails 400 are attached to the L-foot 200 before attaching the solar modules. Depending on how many rails 400 are used, the rails 400 might be joined with a rail-splice 500. Attachment of the solar modules to the rails 400 is with end-clamp 900 and mid-clamp 800.

If a rail-free configuration is selected, then the solar modules may be directly attached to the flex-mount 300, or a skirt 600 and module splice 700 might be attached to the flex-mount 300, and the solar modules attached to the module splice 700 and flex-mount.

The previous description of the disclosure is provided to enable any person skilled in the art to make or use the disclosure. Various modifications to the disclosure will be readily apparent to those skilled in the art, and the generic principles defined herein can be applied to other variations without departing from the scope of the disclosure. Thus, the disclosure is not intended to be limited to the examples and designs described herein, but is to be accorded the widest scope consistent with the principles and novel features disclosed herein.

1. A method for selecting and mounting solar components, the method comprising:
selecting a first panel mounting configuration from a plurality of panel mounting configurations, the plurality of panel mounting configurations including at least a dual-rail panel mounting configuration, a shared-rail panel mounting configuration and a rail-free panel mounting configuration;
arranging a plurality of flashings on a roof surface according to the first panel mounting configuration, the flashings each having an aperture through a raised portion;
selecting, based on the first panel mounting configuration, a first mounting fixture from at least an L-foot or a flex-mount, wherein the L-foot is used with either the dual-rail panel mounting configuration or the shared-rail panel mounting configuration, and the flex-mount is used with the rail-free panel mounting configuration;
attaching a plurality of the first mounting fixtures to the roof surface using at least fasteners that pass through the apertures of the flashings; and
attaching a plurality of solar modules, wherein a first component combination including at least the flashing, the first mounting fixture and the solar module is certified and listed according to a recognized standard, the recognized standard one of at least CE for the European Union, EESS for Australia, ETL for the United States, CSA for the United States or UL for the United States.

2. The method according to claim 1, further comprising:
determining that the first mounting fixture is an L-foot;
attaching a first rail to the first mounting fixture; and
attaching a first solar module to the first rail, wherein the first component combination that is certified and listed according to a recognized standard further includes the L-foot and the rail.

3. The method according to claim 2, further comprising:
attaching the first solar module to the first rail using an end-clamp, wherein the first component combination that is certified and listed according to a recognized standard further includes the end-clamp.

4. The method according to claim 2, further comprising:
attaching the first solar module to the first rail using a mid-clamp, wherein the first component combination that is certified and listed according to a recognized standard further includes the mid-clamp.

5. The method according to claim 2, further comprising:
attaching a second solar module to the first solar module using a module splice, wherein the first component combination that is certified and listed according to a recognized standard further includes the module splice.

6. The method according to claim 2, further comprising:
attaching a second rail to the first rail using a rail-splice, wherein the first component combination that is certified and listed according to a recognized standard further includes the rail-splice.

7. The method according to claim 1, further comprising:
determining that the first mounting fixture is a flex-mount; and
attaching a first solar module to the flex-mount.

8. The method according to claim 7, further comprising:
attaching a second solar module to the first solar module using a module splice, wherein the first component combination that is certified and listed according to a recognized standard further includes the module splice.

9. The method according to claim 7, further comprising:
attaching a skirt to the flex-mount, wherein the first component combination that is certified and listed according to a recognized standard further includes the skirt.

10. The method according to claim 9, further comprising:
attaching a rail-splice to the skirt; and
attaching the first solar module to the flex-mount and the rail-splice, wherein the first component combination that is certified and listed according to a recognized standard further includes the rail-splice.

11. The method according to claim 1, further comprising:
attaching a skirt to the first solar module, wherein the first component combination that is certified and listed according to a recognized standard further includes the skirt.
